(19) United States
(12) Patent Application Publication
(10) Pub. No.: US 2026/0359188 A1
(43) Pub. Date: Nov. 12, 2026

(54) USER-COMPUTER INTERACTION WITH WORKFLOW RULE INFERENCE

(71) Applicant: Microsoft Technology Licensing, LLC, Redmond, WA (US)

(72) Inventors: Conrad WONG GONZALEZ, Sammamish, WA (US); Rachel KINGDON, Duvall, WA (US); Kavishi AGARWAL, San Francisco, CA (US); Esin SAKA, Seattle, WA (US); Anthony Ronald UITZ, San Francisco, CA (US); Alexander Thien TRAN, Bellevue, WA (US); Antonio RUIZ FERNANDEZ, Bellevue, WA (US); Vandana JAIN, Bothell, WA (US)

(21) Appl. No.: 19/224,731

(22) Filed: May 31, 2025

Related U.S. Application Data
(60) Provisional application No. 63/804,454, filed on May 12, 2025.

(51) Int. Cl. G06F 11/34; G06F 16/35

(52) U.S. Cl. CPC G06F 11/3438; G06F 16/35

(57) ABSTRACT

Some embodiments provide or use user-computer interaction with workflow rule inference. Some infer a formal workflow rule from an informal natural language description and context which includes sample data records illustrating application of the rule. Some generate a candidate action from existing formal workflow rules, which are not necessarily limited to inferred rules, and from context which includes data records determined to be in a user account's navigational path. Some vet candidate actions according to a confidence they apply to a record, compliance with user account security permissions, or other criteria. Embodiments facilitate user-computer interaction in some scenarios by suggesting the candidate action in a user interface and implementing a suggestion response, in some scenarios by offering an agent to perform the candidate action, and in some scenarios by invoking an agent to transparently perform the candidate action.

### BACKGROUND

Human-Computer Interaction (HCl) studies how humans interact with computer technology, and explores the design and implementation of such interaction. HCl is also referred to as user-computer interaction. HCl occurs through a variety of unidirectional or bidirectional communication channels, e.g., visual, audio, tactile, and utilizes a variety of built-in hardware and peripheral devices. Goals of HCl vary in different application programs and scenarios. In particular, usability is sometimes a goal, although it is measured in various ways according to various criteria. Improvements in usability and other aspects of HCl remain possible and worth pursuing.

### SUMMARY

Some embodiments address technical challenges arising from human-computer interaction. One challenge is how to improve computational efficiency during interactions. Another challenge is how to improve data gathering speed during interactions. Another challenge is how to improve software usability during interactions, as measured by the time to complete a user task or the number of errors during user task completion. Other challenges are also discussed herein.

One example embodiment determines that a data record is in a navigation path of a user account, submits the data record and a formal workflow rule to a language model with a prompt to determine whether the formal workflow rule applies to the data record and to output any candidate action corresponding to any formal workflow rule that applies to the data record, receives from the language model a candidate action, and uses the candidate action to facilitate a continued human-machine interaction. Some embodiments infer the formal workflow rule from context that includes data records and a natural language description of the workflow rule.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce-in a simplified form some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description is given with reference to the attached drawings. These drawings only illustrate selected aspects and thus do not fully determine coverage or scope.

FIG. 1 is a diagram illustrating aspects of computer systems, including some aspects generally suitable for enhanced systems which include or use user-computer interaction with workflow rule inference (UCIWRI) functionality;

FIG. 2 is a block diagram illustrating aspects of a first example family of enhanced systems which are each configured with UCIWRI functionality;

FIG. 3 is a dataflow diagram of a second example family of enhanced systems which are each configured with UCIWRI functionality;

FIG. 4 is a block diagram illustrating aspects and examples related to facilitating user-computer interaction;

FIG. 5 is a first flowchart illustrating some UCIWRI methods;

FIG. 6 is a second flowchart illustrating some UCIWRI methods; and

FIG. 7 is a third flowchart further illustrating UCIWRI methods, and incorporating as options the steps of each of FIGS. 5 and 6, and also other steps disclosed herein.

### DETAILED DESCRIPTION

### Overview

Some teachings described herein reflect technical challenges faced and insights gained during efforts to improve human-computer interaction (HCl) in computing system architectures which employ artificial intelligence (AI) to infer or apply particular categories of workflow rules. However, the teachings herein are not limited in their scope or applicability to any particular kind of software, or to these particular challenges, solutions, or insights, or to the particular application fields used as examples.

Some HCl scenarios involve dozens, or even hundreds, of data records which potentially relate to a user task. A user task is a task which a user account is performing (or will be performing), e.g., to obtain a computational result such as classification or characterization of a data record, a calculation of a total or a projection or another value based on data records, an authorization or denial of a further processing step based on data records, a preprocessing result in support of a further processing step based on data records, or some other specified computational milestone. Data records relate to a user task as input to the computations which advance or perform the user task, or as targets for receiving output of such computations, or both.

One approach to performing user tasks includes providing a data record search capability. User accounts then locate data records relevant to a given user task by performing searches. However, the search criteria are specified as user inputs, rather than being specified automatically based on the particular user task and other context. This limits the benefit of searches, and invites time-consuming navigational errors. Even with search capability, some approaches lead to click-intensive app journeys where user accounts navigate through dozens of data records, including many which are not ultimately used to accomplish their user tasks, in their journeys to determine and perform their user tasks in an application program.

Another approach to performing user tasks includes providing a macro capability. User-computer interactions are recorded and repeated with different data records. However, the benefits of macros are limited because operations which advance a user task for one data record are not necessarily identical to the operations which will advance a user task for a different data record. Hence, time and computational resources are spent reacting to the inflexibility of macros, including time-consuming reversal of errors caused by applying macro operations to the wrong fields of records, or to the wrong records.

Some embodiments described herein take a different approach. In addition to or instead of search capability and macro capability, for example, they use workflow rule approaches taught herein. The approaches taught herein are referred to collectively as user-computer interaction with workflow rule inference (UCIWRI).

In some UCIWRI embodiments, AI is leveraged to suggest best actions to user accounts for their records, thereby reducing the manual and cognitive efforts of users. Some embodiments provide or use a global list which identifies relevant records for user accounts in an app (i.e., application program) and proactively suggests actions across all their records. In some, actions are personalized to the user account. In some, actions are automatically prioritized by importance. In some, the app proactively navigates a user interface (UI) to an optimal place to take action. Some embodiments perform actions, providing user accounts with help from in app agents and custom agents and in some scenarios, proactive automated actions. In some embodiments, a set of candidate actions is refreshed upon record navigation if there is a change in a related record after generating the candidate action.

Some UCIWRI embodiments use or provide a method of facilitating a continued human-machine interaction, the method performed by a computing system, the method including: collecting a natural language description of a workflow rule; obtaining a sample record which illustrates the workflow rule; submitting the natural language description and the sample record to a language model with a prompt to infer a formal workflow rule and to output the formal workflow rule in a formal notation; and receiving from the language model the formal workflow rule in the formal notation. Formalizing the workflow rule supports effective efficient computations that support performance of user tasks.

This UCIWRI functionality has a technical benefit of addressing a particular vulnerability or failure of other approaches to HCl which rely on user input to reduce the scope of data records that relate to a given user task, by generating formal workflow rules that specify computational activity to perform the user task, reducing user task performance time and decreasing navigational errors. Another technical benefit is increased flexibility, and hence broader application and effectiveness, of formal workflow rules in comparison to macros.

Some UCIWRI embodiments use or provide an HCl method including: determining that a data record is in a navigation path of a user account; submitting the data record and the formal workflow rule to the language model with a prompt to determine whether the formal workflow rule applies to the data record and to output any candidate action corresponding to any formal workflow rule that applies to the data record; receiving from the language model a prediction—a candidate action; vetting the candidate action; and using the candidate action to facilitate the continued human-machine interaction.

This UCIWRI functionality has a technical benefit of improving computational efficiency by focusing user-computer interactions on data and actions that are relevant to a particular user task. Fewer computational resources are expended gathering, displaying, or processing data records that do not relate to the user task. This also provides a technical benefit of faster interactions and fewer navigational errors, without sacrificing HCl effectiveness in accomplishing the user task.

In some UCIWRI embodiments, vetting the candidate action includes at least one of: confirming that the candidate action is consistent with a permission of the user account; or confirming that the candidate action poses a data leak 428 risk below a specified risk threshold.

This UCIWRI functionality has a technical benefit of improving security by preventing or otherwise avoiding performance of insecure operations. Vetting mitigates what could otherwise be a security vulnerability, by vetting an action suggested by a model to ascertain and respond to the action's security risk, prior to presenting the action to a user interface or an AI agent as a candidate action to be performed.

In some UCIWRI embodiments, vetting the candidate action includes at least one of: confirming that the candidate action has a confidence level above a specified confidence threshold; confirming that the candidate action has a priority level above a specified priority threshold; or confirming that the candidate action satisfies a specified responsible artificial intelligence (RAI) criterion.

This UCIWRI functionality has technical benefits of improving HCl computational efficiency, speed, and effectiveness, by focusing user-computer interactions on actions that meet at least minimal criteria as to confidence in the action's relevance and effectiveness, importance of the action relative to other possible actions, and acceptability of the action with regard to RAI. Performance of low confidence actions, unimportant actions, and unsuitable actions is thus avoided, or at least reduced.

These and other advantages and benefits will be apparent to one of skill from the teachings provided herein.

### Operating Environments

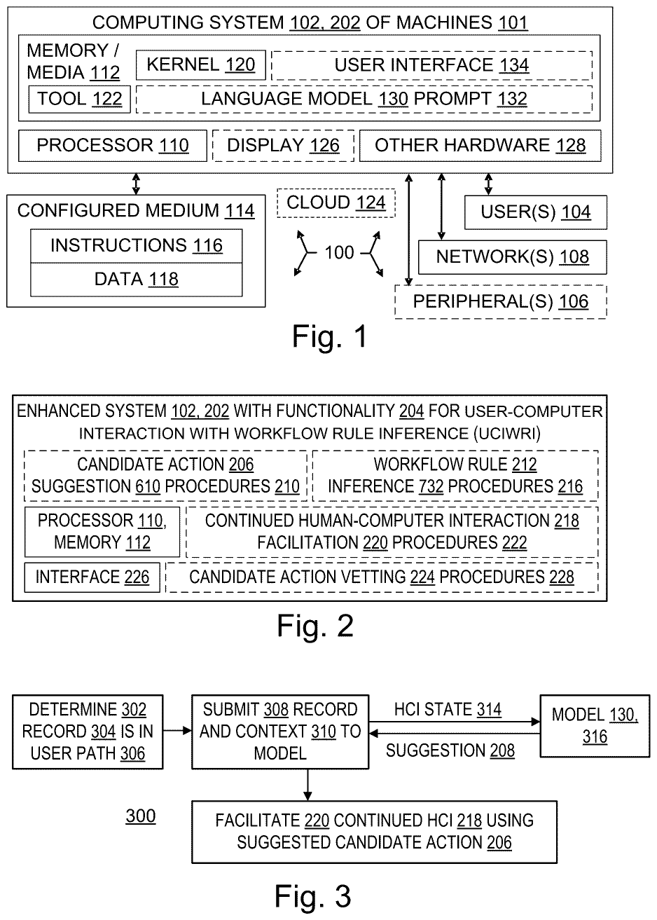

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. Human users 104 sometimes interact 218 with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Storage devices or networking devices or both are considered peripheral equipment 106 in some embodiments and integral parts of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, editors, compilers, debuggers and other software development tools, document processing tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, physical measurements, sensor data, and so forth.

Although an embodiment may include software instructions executed by one or more processors in a computing device, such description is not meant to exhaust all possible embodiments. Embodiments do not necessarily include any software. One of skill will understand that the same or similar functionality of software can often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one or more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) are present in operable communication with one or more processors 110 and memory 112.

In some embodiments or operating environments, a system includes multiple computers connected by a wired and/or wireless network 108. Networking interface equipment 128 provides access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected from, or only intermittently connected to, another networked device or remote cloud or the internet. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings do not provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be properly added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment, which are disclosed herein but not tied to a particular reference numeral. Corresponding drawings may also be properly added.

### More About UCIWRI Systems

Specific items called out in the figures are discussed at various points herein. FIG. 2 illustrates a computing system 102 or other system configured by one or more of the UCIWRI functionality enhancements taught herein, resulting in an enhanced system 202. In some embodiments, an enhanced system 202 includes a single machine, a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with UCIWRI functionality 204. In some embodiments consistent with FIG. 3, components shown in FIG. 2 or other figures are also present.

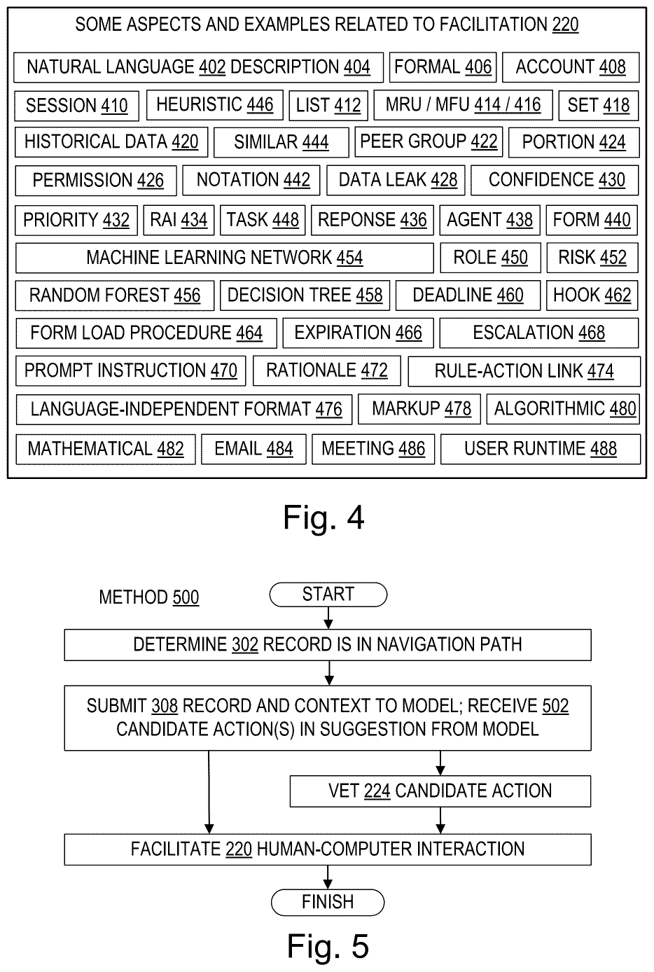

FIGS. 1-7 show reference numerals for some items and some aspects of items that relate to UCIWRI. Failure to receive a reference numeral does not make an item insignificant. FIGS. 1-7 do not individually or collectively or in any subset fully define a comprehensive summary of all aspects of enhanced systems 202 or all aspects of UCIWRI functionality 204. Nor is any figure of FIGS. 1-7 or any smaller group of figures of FIGS. 1-7 by itself a comprehensive summary of all aspects of an environment 100 or another computational context 100 of an enhanced system 202.

FIGS. 5 to 7 are also pertinent to systems 202. FIGS. 5 to 7 are flowcharts which illustrate some methods of UCIWRI functionality 204 operation in some systems 202.

In some embodiments, the enhanced system 202 is networked through an interface 226. In some, an interface 226 includes hardware such as network interface cards, software such as network stacks, APIs, or sockets, combination items such as network connections, or a combination thereof.

Some embodiments include a computing system 202 which is equipped, structured, or otherwise configured to utilize or provide UCIWRI functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. “The word “set” is used to emphasize that the memory 112 is not necessarily in a single contiguous address block or of a single kind, e.g., a memory 112 may include hard drive memory as well as volatile RAM, and may include memories that are physically located on different machines 101, but “memory” alone also includes systems with multiple memories. Similarly, the phrase “processor set” is used to emphasize that a processor 110 is not necessarily confined to a single chip or a single machine 101, but “processor” alone also includes systems with multiple processors. “Set” is not necessarily repeated with each recital of a memory or a processor, but is understood to be implied throughout this disclosure.

All sets herein are non-empty unless described otherwise. At a given point in time any data structure implementing a set identified in this description is empty, or is non-empty, depending on the embodiment and the circumstances. However, even an empty set is defined and detectable in the system 202 as a set when an embodiment includes a data structure implementing the set. The absence of members of a set is not the absence of the set itself.

Some embodiments include a computing system 202 configured to perform workflow rule inference, the system 202 including: a digital memory 112; a processor 110 in operable communication with the digital memory; and a workflow rule inference procedure 216.

Some embodiments include a computing system 202 configured to perform candidate action generation (a.k.a. user input prediction), the system 202 including: a digital memory 112; a processor 110 in operable communication with the digital memory; and a candidate action suggestion procedure 210. Some of these also include an interaction facilitation procedure 222.

Some embodiments include a computing system 202 configured to enable user input to facilitate a continued human-machine interaction 218 by at least candidate action generation, the system including: a digital memory 112; a processor 110 in operable communication with the digital memory; an artificial intelligence model 316 (including but not limited to one or more language models 130) or an interface 226 to an artificial intelligence model 316; a candidate action suggestion procedure 210 which includes instructions 116 which upon execution by a processor determine 302 that a data record 304 is in a navigation path 306 of a user account 408, prompt 308 the artificial intelligence model to determine whether any formal workflow rule 212 applies to the data record, and receive 502 from the artificial intelligence model a candidate action 206; and an interaction facilitation procedure 222 which includes instructions 116 which upon execution by a processor performs at least one of: suggesting 610 the candidate action in a user interface 134 and getting 612 a suggestion response 436 via the user interface, offering 616 access to at least one agent 438 to perform 618 the candidate action and getting 612 an agent offer response 436 via the user interface, or invoking 620 (e.g., via an agent API) at least one agent 438 to perform 618 the candidate action transparently to the user account.

In some embodiments, the artificial intelligence model 316 includes a language model 130, and prompting 308 the artificial intelligence model includes submitting a prompt 132 data structure to the language model 130. The prompt 132 includes data 118 and textual prompt instructions 470 (not to be confused with processor instructions 116). In some embodiments, the data in a prompt 132 includes (by copy or via a link, index, or other identifier) the data record 304 in the navigation path 306. In some embodiments, the data in a prompt 132 includes additional context 310, as discussed herein.

Some embodiments include a computing system 202 configured to facilitate a continued human-machine interaction 218 by at least workflow rule inference, the system including: a digital memory 112; a processor 110 in operable communication with the digital memory; a language model 130 or an interface 226 to a language model 130; a workflow rule inference procedure 216 which includes instructions 116 which upon execution by a processor collect 602 (e.g., via a UI) a natural language 402 description 404 of an informal workflow rule 212, obtain 604 a sample record 304 which illustrates the informal workflow rule, prompt 606 at least one language model 130 to infer 732 at least one formal 406 workflow rule 212 and to output 608 the at least one formal workflow rule in a formal 406 notation 442, and receive 608 from the at least one language model at least one formal workflow rule in the formal notation. Natural language 402 means a language that developed naturally, such as English, French, German, Hebrew, Hindi, Japanese, Korean, Spanish, etc., as opposed to designed or constructed languages such as HTML, JSON, Python, SQL, XML, or other programming languages, mathematical notations, or otherwise artificial languages or notations.

In some embodiments, prompting 606 the artificial intelligence model includes submitting a prompt 132 data structure to the language model 130. The prompt 132 includes data 118 and textual prompt instructions 470 (not to be confused with processor instructions 116). In some embodiments, the data in a prompt 132 includes the sample record by copy or via a link, index, or other identifier. In some embodiments, the data in a prompt 132 includes the natural language description 404, as text. In some embodiments, the data in a prompt 132 includes additional context, such as an example of a formal 406 workflow rule 212. In some embodiments, the data in a prompt 132 includes a prompt instruction 470 specifying the formal notation, e.g., JSON, XML, markup language, “a mathematical equation in Python to perform the calculation” 482, or “a group by statement in SQL” 480. SQL is structured query language.

In some embodiments which generate 502 candidate actions 206, the system 202 includes a candidate action vetting procedure 228 which includes instructions 116 which upon execution by a processor vet 224 the candidate action. Some embodiments vet 224 according to at least one of: a permission 426 of the user account; a role 450 of the user account; a data leak 428 risk 452; a confidence level 430 assigned by the language model; a priority level 432; or a responsible artificial intelligence criterion 434.

In one example, a generated action 206 would update a record 304 or update a particular field of a record 304 for which the user account lacks write permission. Accordingly, vetting 224 prevents use of the action during HCl facilitation 220, e.g., by not supplying (withholding) the action as a candidate.

In one example, a generated action 206 would display or otherwise read data 118 from a record 304 which is designated for user accounts having a budget manager role, but the user account lacks that role designation. Vetting prevents use of the action during HCl facilitation 220.

In one example, a generated action 206 would copy data from a data record X to a data record Y, with Y having fewer permission restrictions or fewer role restrictions or both, thereby creating a risk that confidential data leaks from X to Y. Accordingly, vetting prevents use of the action during HCl facilitation 220.

In one example, a generated action 206 has a confidence level 430 of 0.35 on a scale from 0.0 to 1.0 (other embodiments employ different scales). The confidence level is assigned by the language model in response to a prompt instruction 470 to assign a confidence level that the action pertains to the data record in the path. In some scenarios, the confidence level is based on one or more factors identified in the prompt (and based on corresponding context 310 submitted 308) such as the natural language description 404 of the informal workflow rule, the data 118 used for determining that the data record is in the navigation path of the user account, historical data 420 of a response by the user account to a suggestion of a particular candidate action, historical data 420 of a response by a member of a set of user accounts to a suggestion of a particular candidate action, or a portion 424 of the data record. In this example, the confidence level of 0.35 is below a threshold 726 of 0.7, so vetting prevents use of the action during HCl facilitation 220.

In one example, a generated action 206 has a priority level 432 of 4 on a scale from 0 to 10 (other embodiments employ different scales). In a variation, the priority level is Low, in an enumeration that includes Low, Medium, High, and Urgent. In some scenarios, the priority level is assigned by the user account whose session is active and has the path 306. In some scenarios, the priority level is assigned by another user account. In some, the priority is assigned according to a predefined list, e.g., an action to allow or deny a claim under $100 is Medium priority by default but subject to escalation. In some scenarios, the priority level is assigned according a predefined priority rule, e.g., an action involving customer Z is always High priority. In some scenarios, the priority level is assigned by the language model, in response to a prompt instruction 470, based on an expiration or another deadline 460 extracted from the data record or context. In this particular example, the priority level of 4 is below a threshold 726 of 5, and vetting prevents use of the action during HCl facilitation 220.

In one example, a generated action 206 is submitted to the same or another model and is evaluated 728 against at least one responsible artificial intelligence criterion 434. Some examples of RAI criteria 434 include Fairness, Reliability and safety, Privacy and Security, Transparency, Accountability, and Inclusiveness. In this example, the generated action would violate Security or Privacy or both, by copying an IP address from a data record marked as Confidential into a data record marked as Public, so vetting prevents use of the action during HCl facilitation 220.

In some embodiments which generate 502 candidate actions 206, and in some which infer 732 formal workflow rules, the artificial intelligence model includes at least one of: a language model 130, a machine learning network 454 trained on data discussed here as to prompting 308 or 606 respectively, a random forest 456 or an individual decision tree 458 trained on such data, or a set of clusters 702 which group records 304 according to similarity or historical responses or pertinent actions.

Some embodiments which generate 502 candidate actions 206 include processor instructions 116 which upon execution by a processor hook 462 into a form load procedure 464 and generate 502 at least one candidate action 206 in response to the user account loading 738 a record. The loading is detected 736 via the hook, e.g., as a callback or interrupt or UI-generated message. The record being loaded is treated as the record determined 302 to be in the path 306.

Some embodiments which generate 502 candidate actions 206 include instructions 116 which upon execution by a processor determine 750 whether to include a particular data record 304 (which is not necessarily the data record initially determined 302 to be in the path 306) in the prompt 132 to determine 502 whether any formal workflow rule applies to the particular data record. This allows expansion of a set of records determined 302 to be in the path 306. In this example embodiment, the particular data record 304 is computed from at least one of: an expiration date 466 (which is an example of a deadline 460); a deadline 460; or an association of the particular data record with an escalation process 468 (e.g., per any workflow rule, or per a portion 424 of the record which includes text referring to escalation).

Some embodiments which generate 502 candidate actions 206 include an instruction 470 in the prompt 132 to determine whether any formal workflow rule applies to the data record 304. In some, the instruction 470 includes an instruction to provide a rationale 472 for why an action 206 is considered applicable to the data record 304. Some such instructions 470 include one of more of the phrases “rationale”, “justification”, “explanation”, “reason for the action”, “why the action applies”, or a phrase with a similar meaning.

Some embodiments which generate 502 candidate actions 206 include a data structure 474 which links the candidate action 206 to the formal workflow rule 212 which was used to generate 502 the candidate action. In some, the link 474 includes a pair of pointers, indexes, or other identifiers, one to the action and the other to the rule. In some variations, mixed identifiers are used, e.g., the pair contains a pointer and an index. In some variations, the pair identifies an action and a set 418 whose members include at least one rule 212. In some embodiments, the link 474 is part of the model output. In some, the link 474 is created and populated by instructions 116, based on the model output.

In some embodiments which generate 502 candidate actions 206, and in some which infer 732 formal workflow rules, the formal workflow rule formal notation 442 includes at least one of: a language-independent data format 476 (e.g., a JSON format); a markup language format 478 (e.g., an XML or YAML format; YAML is Yet Another Markup Language); an algorithmic format 480 (e.g., pseudocode, flowchart, or programming language snippet); or a mathematical format 482 (e.g., mathematical equation). In some embodiments, a rule 212 includes two or more such notations 442, while others include only one such notation 442. Some embodiments combine one or more such notations 442 with other data, e.g., textual annotation, or metadata (e.g., rule identifier, natural language from which rule was inferred), or both.

### UCIWRI Processes (a.k.a. Methods)

Processes (which are also referred to as “methods” in the legal sense of that word) are illustrated in various ways herein, both in text and in drawing figures. FIGS. 5 to 7 each illustrate a family of UCIWRI methods 500, 600, and 700 respectively, which are performed or assisted by some enhanced systems, such as some systems 202 or another functionality enhanced system as taught herein. Method families 500 and 600 are each a proper subset of method family 700. Moreover, activities identified in FIGS. 1 to 4 as explicit or implicit method steps are likewise incorporated into method 700, e.g., other software or hardware communicating with a user interface 134, training a language model 130, computationally reading and writing a prompt 132, communicating with a language model 130, a language model executing prompt instructions 132, communicating with a database, data vault, or other data record 304 storage or management mechanism, and so on. Also, steps that are not expressly tied herein to a particular reference number are not thereby excluded from method 700. These diagrams and flowcharts are merely examples; as noted elsewhere, any operable combination of steps that are disclosed herein may be part of a given embodiment when called out in a claim.

Technical processes shown in the Figures or otherwise disclosed are performed automatically, e.g., by an enhanced system 202, unless otherwise indicated. Related non-claimed processes may also be performed in part automatically and in part manually to the extent action by a human person is implicated, e.g., in some situations a human 104 types text into a user interface. Regardless, no process contemplated as an embodiment herein is entirely manual or purely mental; none of the claimed processes can be performed solely in a human mind or on paper. Any claim interpretation to the contrary is squarely at odds with the present disclosure.

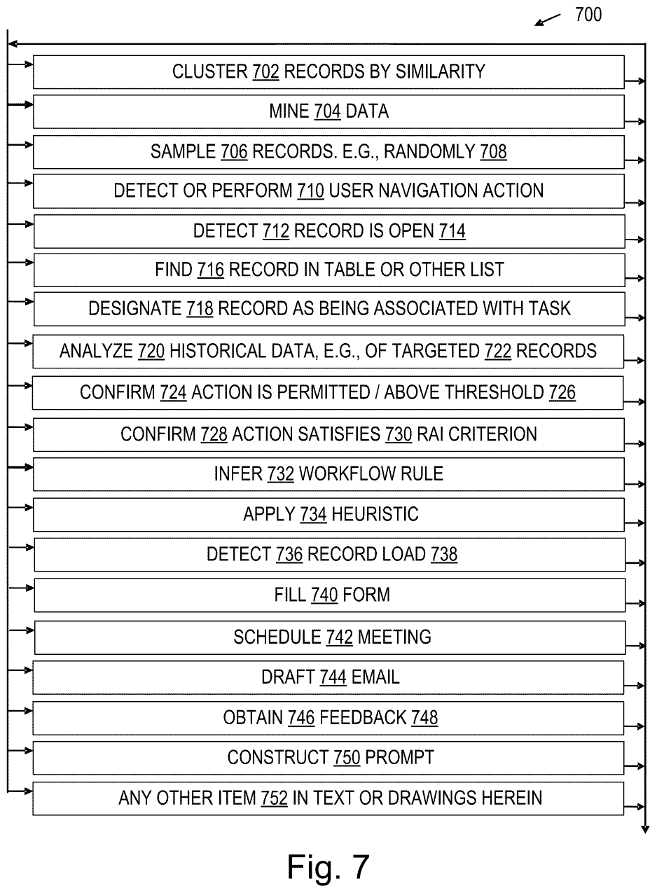

In a given embodiment zero or more illustrated steps of a process may be repeated, perhaps with different parameters or data to operate on. Steps in an embodiment may also be done in a different order than the top-to-bottom order that is laid out in FIG. 7. FIG. 7 is a portion of the textual and figure drawing examples of embodiments provided herein and the descriptions of embodiments provided herein. In the event of any alleged inconsistency, lack of clarity, or excessive breadth due to an interpretation of FIG. 7, the other content of this disclosure shall prevail over that interpretation of FIG. 7.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 700 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 7 or any other figure to be non-operable, the sequence S is not within the scope of any claim. Any assertion otherwise is contrary to the present disclosure.

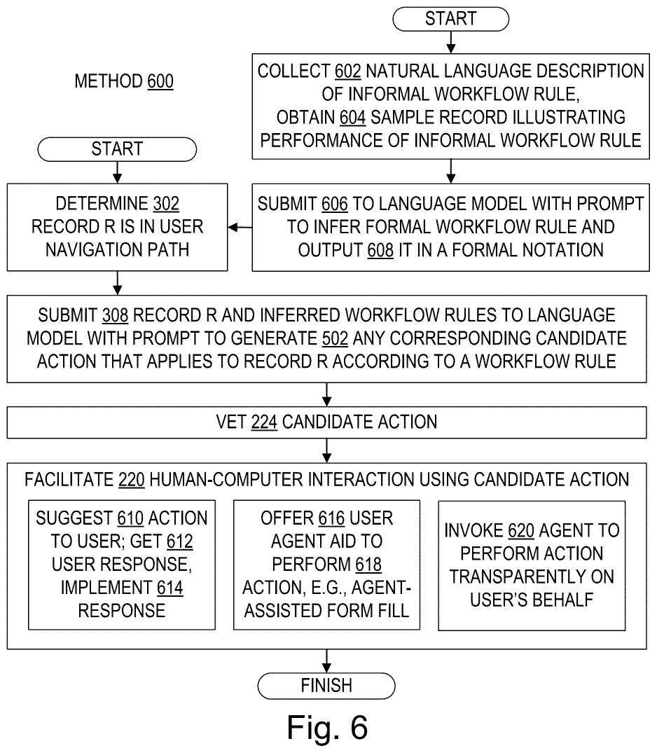

Some embodiments provide or utilize a UCIWRI method 700 which is performed by a computing system to infer a set of workflow rules. The method includes steps 602, 604, 606, and 608. Although for clarity of illustration a flow arrow from steps 606 and 608 to FINISH is not explicitly shown in FIG. 6, that flow arrow is hereby noted.

Some embodiments provide or utilize a UCIWRI method 700 which is performed by a computing system to generate candidate actions 206 using an inferred a set of workflow rules. The method begins at the left-side start in FIG. 6, and continues to FINISH, from step 302 through step 220. In a variation, vetting step 224 is implicit in the model generation of candidate actions and thus is not repeated; see FIG. 5. Alternately, vetting is performed in some scenarios both in the model that generates candidate actions, and outside that model.

Some embodiments provide or utilize a UCIWRI method 700 of facilitating a continued human-machine interaction by at least action generation, the method performed by a computing system, the method including: determining 302 that a data record is in a navigation path of a user account; submitting 308 the data record and a formal workflow rule to a language model with an action generation prompt 132 to determine whether any formal workflow rule applies to the data record and to output any candidate action corresponding to any formal workflow rule that applies to the data record; receiving 502 from the language model a candidate action; and using 220 the candidate action to facilitate the continued human-machine interaction.

In some action generation embodiments, the method 700 includes vetting 224 the candidate action prior to completion of using 220 the candidate action to facilitate the continued human-machine interaction. In some scenarios, vetting 224 occurs prior to starting the facilitation, e.g., the vetting 224 sanitizes or otherwise modifies the action produced by the model, conforming 728 the action with a RAI criterion and then passing the modified action forward to a facilitation procedure 222 as the candidate action. In some scenarios, vetting 224 prevents use 220 of the action produced by the model. In some scenarios, vetting 224 occurs during use 220, e.g., a form fill agent proactively identifies sensitive data in a record and redacts or encrypts that sensitive data instead of simply copying it to another record which has fewer permission restrictions.

In some rule inference embodiments, the method 700 includes, prior to submitting 308 the action generation prompt: collecting 602 a natural language description of an informal workflow rule; obtaining 604 a sample record which illustrates the informal workflow rule; submitting 606 the natural language description and the sample record to the language model with a rule inference prompt 132 to infer at least one formal workflow rule and to output the at least one formal workflow rule in a formal notation; and receiving 608 from the language model the formal workflow rule in the formal notation.

Some embodiments combine rule inference 732 and action generation 502, while other embodiments perform only rule inference 732 or perform only action generation 502. In the combination embodiments, rule inference and action generation are performed on the same system 202, or on different respective systems 202, according to the embodiment. Also, rule inference and action generation are performed in different order relative to each other, or overlap each other, according to the embodiment.

In some rule inference embodiments, obtaining 604 the sample record which illustrates the informal workflow rule includes at least one of: clustering 702 records according to a similarity of user accounts which created and updated a record (allowing the obtaining 604 to favor inclusion of similar records); applying 734 a heuristic 446 (e.g., obtain 604 one or more other records accessed by the user account within a specified time period of navigation to the sample record, or obtain 604 one or more other records whose vectorized natural language descriptions are within a specified cosine similarity or other text similarity distance of the sample record); mining 704 data in at least one set of data records (e.g., mining for links, or for textual references to other records); or randomly 708 sampling 706 at least one set of data records (e.g., sampling from records not yet used as a basis for rule inference).

In some action generation embodiments, determining 302 that the data record is in the navigation path 306 of the user account includes at least one of: detecting 710 (e.g., via a UI API) that the user account navigated to the data record in a user interface; detecting 712 (e.g., via a UI API) that the data record is open 714 in a user interface in a user account session; finding 716 the data record in a list 412 of at least one most recently used (MRU) data records of the user account; finding 716 the data record in a list of at least one most frequently used (MFU) data records of the user account; analyzing 720 historical data of navigation (e.g., to determine MRU 414 or MFU 416 record(s)) during the continued human-machine interaction; finding 716 the data record in a list of at least one data record designated 718 as associated with a user task 448 being performed by or on behalf of the user account (e.g., user task includes reviewing and taking disposal action on a list of claims submitted in past 48 hours); analyzing 720 historical data of at least one user account response to at least one other candidate action (e.g., past five suggestions to apply actions linked 474 to same rule and applied to data records in the same record category have been accepted by this user account); analyzing 720 historical data about data records targeted 722 by a set 418 of user accounts (e.g., when a user account peer group 422 took action on a data record in this category, they also took action on records in these two other categories at least 60% of the time); or analyzing 720 historical data about actions taken on other data records by a set of user accounts (e.g., when a user account peer group 422 took action X on a data record with the same index field as this data record, they also took action Y on another record at least 70% of the time).

In some action generation embodiments, the method 700 includes submitting 308 to the language model at least one of: the natural language description 404 of the informal workflow rule; data 118 used for determining 302 that the data record is in the navigation path 306 of the user account; historical data 420 of a response by the user account to a suggestion of a particular candidate action (e.g., user account dismissed three prior suggestions to escalate); historical data 420 of a response by a member of a set 418 of user accounts (e.g., a peer group) to a suggestion of a particular candidate action; or a portion of the data record (e.g., comments section, notes section, memo section).

In some action generation embodiments, using 220 the candidate action to facilitate the continued human-machine interaction includes at least one of: suggesting 610 the candidate action in a user interface, getting 612 a suggestion response (e.g., accept, reject, dismiss, modify, forward, postpone) via the user interface, and implementing 614 the suggestion response; offering 616 access to at least one agent to perform 618 the candidate action (e.g., “would you like an AI assistant to help?”), getting 612 an agent offer response via the user interface, and implementing 614 the agent offer response; or invoking 620 at least one agent to perform the candidate action transparently (e.g., with little or no further user input required) to the user account.

### UCIWRI Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, is configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing UCIWRI functionality 204 as disclosed herein. The Figures thus help illustrate configured storage media embodiments and process (a.k.a. method) embodiments, as well as system and process embodiments. In particular, any of the method steps illustrated in FIG. 3 or FIGS. 5 to 7, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform a UCIWRI method 700.

Some embodiments include a computer-readable storage medium configured with data 118 and instructions 116 which upon execution by a processor 110 of a computing system 102 perform a method 700 of facilitating 220 a continued human-machine interaction, the method including: determining 302 that a data record is in a navigation path of a user account; submitting 308 the data record and a formal workflow rule to a language model with an action generation prompt to determine whether any formal workflow rule applies to the data record and to output any candidate action corresponding to any formal workflow rule that applies to the data record; receiving 502 from the language model a candidate action; vetting 224 the candidate action; and using the candidate action to facilitate 220 the continued human-machine interaction.

In some embodiments, vetting 224 the candidate action includes confirming 724 that the candidate action is consistent with a permission 426 of the user account.

In some embodiments, vetting 224 the candidate action includes at least one of: confirming 724 that the candidate action poses a data leak risk below a specified risk threshold; confirming 724 that the candidate action has a confidence level above a specified confidence threshold; confirming 724 that the candidate action has a priority level above a specified priority threshold; or confirming 724 that the candidate action satisfies 730 a specified responsible artificial intelligence criterion.

In some embodiments, using 220 the candidate action to facilitate the continued human-machine interaction includes at least partially proactively filling 740 a form 440. In some scenarios, form filling includes, e.g., copying data into the form from one or more data records, or calculating a new value from one or more data records and placing the new value in the form.

In some embodiments, using 220 the candidate action to facilitate the continued human-machine interaction includes proactively scheduling 742 a meeting 486, e.g., via a scheduling app or calendar app API.

In some embodiments, using 220 the candidate action to facilitate the continued human-machine interaction includes proactively drafting 744 an email 484, e.g., via an email app API.

Machine Learning Models, including Language Models

A language model 130 or other machine learning model 316 within or utilized by an enhanced system 202 is not necessarily a large language model (LLM) in every embodiment, but it is an LLM in some embodiments. For present purposes, a language model is “large” if it has at least a billion parameters. For example GPT-2 (OpenAI), MegatronLM (NVIDIA), T5 (Google), Turing-NLG (Microsoft), GPT-3 (OpenAI), GPT-3.5 (OpenAI), GPT-4 (OpenAI), and LLaMA versions (Meta AI) are each a large language model (LLM) for purposes of the present disclosure, regardless of any definitions to the contrary that may be present in the industry. Some examples of models include language models which are large language models, large language models (LLMs), multimodal language models, and foundation models.

Language model stability is a consideration in some embodiments and some scenarios. Instability leads to inconsistency in language model responses to prompts. Language model stability is sometimes dependent on language model parameters. Some different large language models have different stability parameters, and some exhibit different variability between answers to the same question even while using the same stability parameters. Some models are stabilized by adjusting parameters such as temperature, frequency penalty, presence penalty, or nucleus sampling, and also or instead by constraining the queries sent to a given instance of the model. In some scenarios, model performance is optimized by use of suitable training data, fine-tuning, prompt engineering, or a combination thereof.

Implementing a machine learning model 130 involves setting weights, biases, thresholds, associations, or other values in a machine learning network, a random forest, a decision tree, a set of clusters, or other machine learning structure, in response to specific training data. Differences in the training data values utilized, including but not limited to differences which result from different selections of data features (e.g., independent variables, predictor variables, or attributes), will result in a different model, namely, a model having different internal logic than another model trained on different data 118, or trained via different prompts 132, or both. Similarly, different output feature selections correspond to different machine learning models, e.g., both as to a distinction between continuous variables and classification variables, and as to different continuous variables (e.g., a model predicting house size is different than a model predicting house price) and as to different classification variables (e.g., a model classifying images as cats or dogs is different than a model classifying images as numeric digits). A machine learning model trained on one set of features or trained to produce a particular kind of output does not have the same functionality as a machine learning model trained on different data features or trained to produce different kinds of output, or both.

In some embodiments, a model 316 includes (a) a machine learning network, random forest, or other machine learning structure, together with (b) a selection of one or more input features, and (c) a selection of one or more output features. The environment 100 of a machine learning model includes data 118, but does not itself specify the particular feature selections of any given machine learning model 130.

One internal prototype utilized a GPT-4.1 mini model 130.

### Additional Observations on UCIWRI

Support for the discussion of UCIWRI functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

In the diagrams and the claims, singular includes plural, e.g., “vet candidate action” means “vet at least one candidate action”. Also, repetition of a step is allowed even if a diagram does not explicitly show it or a claim does not explicitly recite it, e.g., an agent could be invoked several times to perform actions, or several agents could be invoked to perform respective actions. Also, additional steps or additional data or both can be present even if they are not explicitly shown in the diagram or explicitly recited in the claims.

One internal prototype provides advances on process mining tools or techniques, and advances on recommender system tools or techniques.

One particular example of workflow rules in some scenarios is business rules, sometimes referred to as business logic. Embodiments are not limited to, and do not necessarily include, business rules. More generally, a set 418 of one or more workflow rules is sometimes referred to as logic. A focus of some embodiments is data record-based workflow rules, particularly for navigation through data records, for input of selections or commands directed at data records, for predicting user input as candidate actions, or for combinations thereof.

Some embodiments analyze 720 historic data of other actions taken by a larger set of user accounts on records of a similar nature to obtain context data to aid a model. In some, a table 412 of records is computed from a larger set of records than the one that is open or otherwise placed in the navigation path 306 by user navigation action, with the larger set analyzed for similarity and similar records put into a global list 412. In some scenarios, a user account will have access to hundreds of records but the embodiment provides a message such as “here are five records most important to you now”.

Some embodiments analyze 720 historic data of the particular user account, including whether action suggestions 208 were accepted or declined. This analysis, together with a measure of similarity of the current candidate action to other actions, indicates whether the current candidate is likely to be accepted. Hence, whether it should be suggested.

In some embodiments, candidate action suggestion procedures 210 include instructions which upon execution by a processor perform one or more of the steps 302, 308, 502, 610, 612, or steps described herein as part of any of these.

In some embodiments, workflow rule inference procedures 216 include instructions which upon execution by a processor perform one or more of the steps 602, 604, 606, 608, 732, or steps described herein as part of any of these.

In some embodiments, continued HCl facilitation procedures 222 include instructions which upon execution by a processor perform the step 220, or steps described herein as part of step 220.

In some embodiments, candidate action vetting procedures 228 include instructions which upon execution by a processor perform the step 224, or steps described herein as part of step 224.

In some embodiments, functionality 204 uses non-language model solutions 316 instead of, or in addition to, language model solutions 130, 316. Suitable solutions 316 include AI and Data Mining techniques, including and not limited to language models 130. Although not explicitly shown, some of these embodiments conform with one or more of: a first variation of FIG. 6 in which “language model” is replaced by “non-language model”, a second variation of FIG. 6 in which “language model” is replaced by “language model and non-language model”, or a third variation of FIG. 6 in which “language model” is replaced by “language model or non-language model”.

Some embodiments separate 1) generating and storing the rules 212 based on sample records and contextual 310 AI, and 2) applying those rules to a record to determine suggested actions 206. Separation is embodied, e.g., in performance or non-performance of method steps, in presence or absence of executable instruction procedures or other components, or both. In this way, the rules can be used for different purposes (suggesting actions, automation, etc.), and the determination of action for a record becomes a relatively lightweight process.

In some embodiments, a pointer, table, or other data structure 474 links a suggested action to the workflow rule (or rules) that was used to generate the suggested action.

In some embodiments, each workflow rule is associated with an entity (data table) or a form (subset of an entity). An entity has multiple records in it in some scenarios. Some embodiments choose (604 or 706 or both) records randomly, based on at least one of: an expertise-level of people who updated it, how much and what kind of information exists in a record, when a record was created, or when a record was last updated. Some embodiments cluster 702 records and use stratified sampling to increase diversity in record selection. In some, record clustering 702 uses the similarities of user accounts 408 that created and updated these records, allowing the embodiment to use heuristics or data mining techniques to choose which records when obtaining 604 a sample record which illustrates a workflow rule. Some embodiments take a random sample of records that is adjusted based on a max number of tokens allocated for the rules generation 732. Some embodiments leverage AI to identify a minimum set 418 of records that represent all the existing scenarios in the table, and to filter the relevant information. An advantage of some embodiments due to their architecture is that the complexity of this data collection and context gathering is able to increase to improve the accuracy and reliability of generated actions without increasing cost or responsiveness of generating an individual action.

In some embodiments, an LLM or other language model 130 makes a record similarity determination 444, in order to analyze actions taken by other user accounts on similar records, based on a maker account's descriptions of the actions and the model's general knowledge. In some embodiments, this mechanism is supplemented or replaced with more specific data mining 704 techniques to increase consistency and enable recognition of more complex patterns. One such case finds similar 444 user accounts, based on at least one of: what kind of records and fields they are updating, how long they have been modifying entities for type, how long they have been a user, their context at a given time, location, expertise, or other criteria.

Some embodiments leverage due dates 460 or commitments 460 included in a record's documentation. In addition, some embodiments only include records that are available to the user based on their permissions. Some enforce 724 Role-Based Access Control (RBAC) constraints on records. Some embodiments ensure 724 that recommended actions are aligned with user privileges 426, including what tables, fields, and records a user account has legitimate access to. This alignment helps ensure that the suggested actions are not only relevant but also permissible within the user's access rights, thus enhancing security and regulatory compliance.

Some embodiments also compute 302 which data records are presumed to be currently relevant to the user account 408 based on at least one of: other similar user accounts, a user account's context 314, 310 at the time of the FIG. 6 DETERMINE step, whether the user account shared a screen capture or what other records it modified recently, or a user account's work patterns (like approving or denying requisitions every Tuesday at 10 am, etc.).

In some scenarios, determining that the data record is in the navigation path of the user account includes detecting 710 (e.g., via a UI API) when a user hovers on a record or clicks on a record, or goes to a record. Each of these navigational events potentially triggers a human-machine interaction 218, e.g., suggesting an action.

In some embodiments, optional context 310 given to the language model to help the model select 502 candidate actions includes at least one of: identification of or copy of one or more recently modified records and fields, documents shared with the system, usage patterns (e.g., reviewing travel proposals every Monday), specified events such as end of fiscal year, data that already exists in the record, and similar user accounts (identification, not copy).

In some embodiments, particularly those employing non-language model approaches, the workflow rule 212 is in an algorithmic format 480 or in a mathematical format 482.

In some embodiments, inferred candidate action vetting 224 includes checking 724 a suggested candidate action against a user account role 450. For example, in some scenarios a user account has at various times a chair role, a manager role, or an author role, and different vetting is applied based on which role is currently being used.

Some embodiments let a user account perform the candidate action without any further support (in the form of agent invocation or proactive action performance) after the candidate action is vetted and presented 610 in a user interface 134.

Some embodiments analyze 720 historic data such as previous record handling, when inferring 732 a workflow rule. Some use a natural language description of a rule, but narrow and formalize the natural language description into formal notation 442, e.g., formal logic 212, or a rule 212 which includes a pattern detection predicate.

In some embodiments, rule inference (also called phase 1 herein) 732 can happen earlier than action generation 502, allowing inferred rules to be stored, and then be shared across a set of user accounts with similar compatible security permissions. The action generation (phase 2) 502 then occurs on-demand, e.g., in nearly real-time or in real-time as a user account navigates within an application 122 that provides the user account 408 with access to the data record, during performance of a user task.

Some embodiments determine 302 that a record is more closely related than another record based on historic data or workflow rule definitions for escalation 468. That is, some records are more likely to be implicated in an escalation than other records, and thus should be included in model context 310 when generating a candidate action.

Some embodiments determine 302 that a record should be included in model context 310 when generating a candidate action based on an expiration date, or another deadline 460, which is stated in or associated with the record.

In some embodiments, a user account's peer group(s) is identified based on one or more criteria. In some, a user account has multiple peer groups 422 based, e.g., on one or more of: organizational distance (e.g., user accounts that work on Product X), the user account's role (e.g., engineers who work on Product X), similar job title using vector-based cosine similarity, or user accounts that access similar resources (e.g., user accounts that access the shared site for Product X, or common online sites that are accessed).

Some embodiments send an action suggestion 208 to a user interface, which displays 610 the suggestion, asks for a response indicating accept/decline, and automatically navigates to a related record. Some embodiments let the user account do an action semi-automatically (after a go command), in some scenarios repeating the action on multiple records with user review along the way. Some embodiments offer 616 use of an agent to help perform a suggested action. Some embodiments proactively invoke 620 an agent which does the suggested action transparently. Some embodiments implement 614 an action suggestion via AI interaction to perform 618 actions to finish a user task, e.g., to fill in a form, schedule a meeting, draft an email, etc.

In some embodiments, candidate action generation 502 includes the following. Workflow rules are inferred 732 from natural language (NL) descriptions, by mapping the NL to associated patterns in the user-facing app software 122. Record scoping determines 302 which records actions are being generated for. Inferred rules are applied to a current record (in UI focus) to find valid actions. Candidate actions are filtered (vetted) 224, e.g., to display only high-confidence candidates.

In a particular example of rule inference, a maker account input includes an entity (record categorization) of “Claims” and informal actions: “Approve a claim: approve a claim if it follows the company policies. Reject a claim: reject a claim when it violates the company policy. Update the claim with justification.” The maker account input, sample records, and context (a.k.a. Contextual AI) are submitted to a rule inference model. The Contextual AI in this particular example includes previously accepted and declined actions, and MFU fields.

In this particular example of rule inference, an inferred rule description includes the following. “Approve a claim. Rule: The claim can be approved if the category is correct and the amount is within the acceptable range (50-1000 USD). The status is updated to ‘Approved’ and the status description reflects the approval reason. Reject a claim. Rule: The claim is rejected if the category is incorrect or the amount exceeds the acceptable range (above 1000 USD). The status is updated to ‘Rejected’ and the status description reflects the rejection reason.”

In a particular example of action generation, a user navigated record includes the following fields with the indicated values. Amount: $100, Description: Ski Goggles. Category: Outside Activity. Status: Pending. The user navigated record and the inferred rule from the above particular example of rule inference are a computational basis for action generation. In this particular example of action generation, two actions are generated. One is identified as Action #2, with Confidence 5 and Rationale “This was a guess”. The Confidence is below a confidence threshold, so this Action #2 is not suggested. The other generated action (Action #1) includes the following. “Action: Approve a claim. Confidence: 100. Rationale: The category is correct, and the amount is within the acceptable range (50-1000 USD). The claim status is currently Pending, so the action has not yet been applied.” An action filter 228 allows Action #1 to pass, so Action #1 is shown in a user interface as part of a suggestion.

One embodiment includes a Maker Runtime 488 and an End User Runtime 488. In the Maker Runtime, a maker account onboards tables with action definitions and context, and then publishes an app (Model App). The embodiment stores maker-defined actions and context in an AppElement Table. In the End User Runtime, at one point in time an end user account opens Model App, and the embodiment reads AppElement Table and checks whether the workflow rules (logic) for Model App are up to date. If not, the embodiment infers rule(s) for each action based on sample records and Contextual AI, with the inference procedure reading from AppElement Table and from a set 418 of Contextual AI traits. The resulting inferred logic is stored in a logic table. At another point in time the end user account navigates to a particular record. The embodiment checks whether there are actions already generated. If not, the embodiment generates actions for the particular record, reading from the logic table. The embodiment checks whether the generated actions are grounded in maker account input and above the confidence threshold. If so, they are stored in a Generated Actions Table, and the runtime 488 is notified to update actions shown in a UI, e.g., in an agent pane. If the earlier check determined that there are actions already generated, these are shown in the UI.

In some embodiments, a maker account onboards an app to Suggested Actions. It does this within a Modern App Designer by picking and annotating specific entities within an app to provide a list of applicable actions for each entity. After annotating an app these changes are registered within app storage on publish. At the start of a session, a request is made to an Intelligence Service Endpoint to check if up to date rules already exist in Dataverse. If not, for each entity onboarded to Suggested Actions, this example embodiment evaluates the list of maker account defined actions, Contextual AI data, and a sampling of the data present in the entity are a computational basis to define a set 418 of rule criteria for when each action is applied. While the user account navigates the app, actions are generated at run time by passing app and user context to an endpoint hosted within Intelligence Service (IS), which generates new next best actions (NBAs) (candidate actions 206) if needed as the user account navigates the app. Intelligence Service serves as an orchestrator and as a host platform for scoping, generating, maintaining, and prioritizing actions 206 to be displayed in end user accounts. Some embodiments utilize three endpoints for three respective internal computational tasks: generating action rule criteria for an entity, selecting and generating actions for individual records, and retrieving and prioritizing actions for display to a user account.

In some embodiments, a Suggested Action UCI Client runtime resides directly within a UCI player runtime. It is responsible for requesting generation of actions and interacts with the action generator IS endpoints through an IntelligenceServiceRuntime hosted within UCI. As a user account navigates the app some embodiments hook directly into form load to generate NBAs on the fly as the user account loads a record. UCI refers to Unified Client Interface, a runtime 488 and user experience powering, e.g., Microsoft Power Platform Model Apps & Dynamics™ solutions (marks of Microsoft Corporation).

These NBAs 206 are stored within a suggested actions table for later re-use and presented for up to some specified time limit (e.g., 7 days after creation), and up to an additional specified time limit (e.g., 7 days) once completed. If there has been an update to a record, this example embodiment refreshes the suggested actions before the specified expiry. Actions are exposed to users within an Agent pane 134 throughout each app session. This pane interacts with a second endpoint hosted within IS to examine the user context, fetch the list of suggested actions and filter to only those applicable to the current user based on their historical behavior characteristics. Up to N (e.g., 5, 10, or 20) active actions are shown in a user interface at a given time. As user accounts complete user tasks or dismiss user tasks, the suggested action record state is updated to reflect the action has been completed by the user account. Any actions that are still considered relevant are saved and shown again in a future session.

With regard to candidate action generation, some embodiments leverage maker account input as well as Contextual AI to create a set of workflow rules for when and why an action is applied. When processing a particular record, some embodiments compare the state of the record against those rules to determine which actions are applicable to a record.

In some scenarios, a motivation behind this two-step process (rule inference, action generation) is to pre-calculate generating workflow rules built on non-user specific data. This rule generation 732 is a relatively expensive operation but is re-usable across many records. Then when it comes time to evaluate a particular record, some embodiments run a much lighter weight prompt that considers a much more narrowly scoped set 418 of data that will be cheaper to execute from a token consumption perspective, and other computational resource consumption perspective, as well as be more responsive from an end user perspective. Examples of computational resources include tokens, processor cycles, memory space, network bandwidth, and electricity.

Some embodiments provide or use a method of facilitating a continued human-machine interaction, the method performed by a computing system, the method including: determining that a data record is in a navigation path of a user account; inferring a candidate action, the inferring computed from at least: a natural language description of the candidate action, historical data of navigation during the continued human-machine interaction, historical data of user account response to at least one other candidate action, and at least a portion of the data record; vetting the candidate action; presenting the candidate action in a user interface; receiving a selection via the user interface; and implementing the selection.

In some embodiments, a suggested actions agent 438 provides an alternative to manual, time consuming and high cognitive load processes by enhancing HCl to identify a next best action for a specific record (prepare), perform the next best action effectively (perform), and identify the most important/urgent records to act on (prioritize).

In some embodiments, rule generation doesn't consider user-specific telemetry. Filtering and prioritizing help the embodiment determine the specific actions that are relevant to a particular user account. Some embodiments utilize direct customer navigation to determine 302 at least one record of interest. Some suggested actions are configured in a maker account experience UI and visualized in an end user experience UI. In some embodiments, a list of suggested actions 206 varies record by record, depending on the record status.

As a particular example, some embodiments include an orchestrator which sends a rule generation 732 prompt to an API surface configured to call into GPT models in a compliant and secure way. A response from the API surface has a form such as:
[
{
   “Rationale”: <A brief explanation why the logic was created>,
   “MakerActionName”: <Selected Maker Action>,
   “Rule”: <The logic tied to the maker defined action>,
   “Steps”: <Explanation of the steps required to execute the logic>
}, . . .
]

Continuing this particular example, the orchestrator includes a Generate Rule Skill component, which includes or provides a Pseudo-prompt 132 and a Grounding Context. The Pseudo-prompt includes instructions 470 such as:
#system
You are an assistant that helps determine rules for actions on a Microsoft Dataverse™ entity. Entities in Dataverse function as tables in a database. Each entity represents a data structure with rows (records) and columns (fields). To make this determination you have the following inputs:
   Action names and their definition for the entity
   Sample set of records for the entity
   Distribution of most frequently updated fields
   Acceptance history for the actions in the entity and their previous set of rules, if they exist
#user

These are your actual inputs:

Action descriptions: {{maker_actions}}

Set of records per scenario: {{sample_records}}

Acceptance history for the actions in the entity: {{feedback_loop_content}}

Continuing this particular example, the Grounding Context includes Maker Actions, Sample Records, and Contextual AI. Each Maker Action includes a data structure such as:
MakerAction[]:
MakerActionName: String
MakerActionDescription: String

Each Sample Record includes Record Live Data and Entity Context. Record Live Data includes: Last N updated records for this entity, where N depends on token allocation, with Choice columns mapped to display name fields and Related fields mapped to display name fields. Entity Context includes an Entity display name.

Continuing this particular example, the Contextual AI includes a Most Edited Form Fields Trait, which identifies fields that are updated together along with update counts. The Contextual AI also includes a Feedback Loop Trait 748, which identifies Previous Generated Rules with their completion and dismissal counts, and identifies associated records that were completed or dismissed.

In some embodiments, LLM inputs include:
Maker account defined actions: Set of maker account defined actions and additional description context on when a user performs this action.
{
   Table: “Claims”,
   Actions: [
      {
         MakerActionName: “Approve a claim”,
         MakerActionDescription: “When a claim is valid”
      },
   . . . /* Other Actions */
   ]
}
Contextual AI Most Edited Form Fields Trait: Sets of fields that are updated together, alongside their update counts.
Contextual AI Feedback Loop Trait: Previous generated rules with their completion and dismissal counts; associated records that were completed or dismissed.
N most recently updated records for the table: the quantity varies based on token allocation and column content. Some embodiments retrieve this information by leveraging a dataverse ‘modified on’ column.

In some embodiments, workflow logic is generated using a model (e.g., LLM) prompt. The prompt construction 750 considers the maker account input, and enriches it by inferring 732 workflow logic 212 from context data and sample records that show how user accounts are interacting with the table. These are the high-level instructions 470 for the LLM in an example prompt:

You should iterate over each of the actions included in the maker account input and perform the following steps for each one:
1—If there is acceptance history, take the records where the action was completed, and identify patterns among them and contrast them with the records where the action was dismissed
2—Determine which sample records best represent the action
3—Analyze the sample records to determine the workflow rules that apply to that action. Make sure you compare the selected records and contrast them to the records not assigned to the action
4—Combine the findings in steps 2 and 3 to infer the rule that determines when to apply that action, and use the results to enhance the action description.

When NBAs are requested for a record, some embodiments use a lighter weight prompt that compares criteria specified by the workflow rules against the current state of the record.

In some embodiments, LLM outputs include:
A final output is evaluation criteria for each action to determine when it should be applied for a particular table. Below is an example of the output of this step.
{
   Actions: [
      {
         MakerActionName: “Approve a claim”,
         Rule: “The category must match, and the amount should be between 50-150.”,
         Steps: “Change the status field of the record from pending to approved. Modify the description field to indicate that the record satisfies requirements.”,
         Rationale: “Why we deduced this rule”
      },
   . . . /* Evaluation of other actions */
   ]
}

In some embodiments, LLM inputs for action generation include a Set 418 of possible maker account actions enriched with workflow rules inferred by the rule generator: A previous LLM Step appends explicit workflow rules and execution steps to the maker account defined actions. For example:
{
   Actions: [
      {
         MakerActionName: “Approve a claim”,
         MakerActionDescription: “When a claim is valid”,
      Rule: “The category must match, and the amount should be between 50-150.”,
      Steps: “Change the status field of the record from pending to approved. Modify the description field to indicate that the record satisfies requirements.”,
      },
   . . . /* Evaluation of Other Actions */
   ]
}

In this example, LLM inputs for action generation also include Target record live data: The live data of the target record. Choice and related columns are mapped to display NL values instead of numerical representations.

Some embodiments also a slot for justification (rationale) 472 of the newly created rule. The justification is used in some scenarios as part of working memory for the LLM, so it is early or even first in a list of outputs. With justification, the LLM has tokens to reason (working memory), and the MakerActionName, Rule, and Steps are heavily biased by this reasoning output.

In some embodiments, suggested actions are generated using an LLM prompt. The prompt construction 750 considers the target record and the inferred rules determined by the rule generator, and identifies which actions apply to the record, including a confidence score that can be used to filter the higher quality suggestions. These are the high-level steps 470:
1—Go through the list of actions, check if the target record meets the rule associated with the action
2—For each action, calculate a score from 0 to 100, that indicates a level of confidence that the action applies to the target record
3—If any of the selected actions have already been applied to the target record remove them from the suggestion

As to LLM output, in this example the prompt will result in a list of applicable actions 206, a justification for why the NBA applies to the record, a description of how to apply the action, and the confidence level for each action. The output will be in JSON format. JSON is a language-independent data format. Following is an example output.
{
   Actions: [
      {
         ActionRationale: “The pending claim for Contoso Shoes should be approved as it both fits the declared category and the price limit.”,
         MakerActionName: “Approve a claim”,
         ActionTitle: “Approve claim number 1029 for Contoso Shoes”,
         ActionInstructions: “Change the status field to approved. Fill the status reason field to ‘The Contoso Shoes claim satisfies both the price and category requirements.’”,
         Confidence: 95
      },
   . . . /* Evaluation of other actions */
   ]
}

In some embodiments, suggested actions are represented using certain points of data that are surfaced to a user account to enable interaction:
Action Title (Text 128 characters)—High level call to action to be displayed to the user
Action Execution Steps (Text 1024 characters)—Short description of the suggested action
Completed On (Searchable dateTime-optional)—Time at which an action was marked as completed. Valid for Update
Completed By (searchable lookup-optional)—nullable column populated with the user ID of the user who completed this action. Valid for Update
Table Name—Searchable string-The logical table/entity name to be used for UI navigation.
Row Id—Searchable Guid-Associated Row Information to Be Used for Ui navigation.

Some embodiments also track 746 one or more of the following pieces of information 748 for filtering, maintenance, and improving action relevancy over time.
Action Id (Searchable GUID—Primary column)—Unique Identifier for this NBA
App Id (Searchable GUID)—The app for which this NBA applies, only NBAs for a particular app are considered during a particular session.
Maker Account Action Name (Searchable Text 128 characters-Optional)—The maker account inputted action name that is used internally to bucket actions and improve suggestions based on user account completion/rejection.
Generator Tag (Text 200 characters)—Tag for which generator provisioned the action, e.g., keyed to entity name+manager
CriteriaId (Lookup-Optional)—Lookup column that links an action back to the criteria set
Rationale (Text 1024 characters-optional)—Generated rationale for why an action was considered applicable.

In some embodiments, an internal SuggestedActionCriteria Table stores generated action criteria to help an action generator 210 decide when an action is applicable to a particular record. This is a resource intensive calculation that doesn't rely on any user specific context, so it is stored to be shareable across user accounts 408 and sessions 410. In one version, this table includes:
App Id (GUID Searchable)—The app 122 for which this applies.
Table Name (string Searchable)—The logical name of the table to which this applies.
Criteria list (JSON up to 16 k characters)—a JSON object with the following format
MakerActionName—The action name as directly specified by the maker, e.g., “Approve claim”
MakerActionDescription—The action description for the associated action specified by the maker account describing how the action is performed.
Inferred Criteria—The natural language informal rule that describes when this action applies, e.g., “Status must be pending, the category must match, and the amount must be between 0 and 100”
Steps—The natural language description on how to execute the workflow rules.
Rationale—LLM Rationale for generating the rule and steps.

In some embodiments, actions are user job to be done (JBTD) focused user tasks 448 such as Resolve a case, as opposed to more widely applicable actions like “Delete”. In some embodiments, a maker account is only providing actions information in NL and the embodiment is leveraging it to infer 732 the workflow logic to propose when an action is relevant, such as to propose “Resolve a case” when that solution has been added to a record and a status is that a stakeholder confirmed the solution. This beneficially reduces cognitive load for users 104, hence increasing focus on more relevant records and actions, with the corollary benefits of increased focus noted elsewhere herein (e.g., reduced computational resource use, fewer navigation errors, faster record processing to accomplish user task). The embodiment identifies what to do based on analysis of each record/records which it is solving via dynamic proposal with the help from maker account input+historical data+contextual AI.

In some embodiments, a global list of agent-proposed user task actions 206 navigates 710 the UI to correct places to do a candidate action, without the user account having to manually go to each record to determine what to do and where to do it.

Some embodiments collect NL maker account input for action names+descriptions, and some use those action names verbatim in formalized rules 212.

Some embodiments include a feedback loop (User account->Maker account) to communicate 746 how each Action is performing, e.g., in terms of user account accepting/rejecting/dismissing/completing the Action.

Some embodiments asynchronously trigger to proactively generate and maintain actions during inactive user sessions 410.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage-RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as determining 302 a record is in a user account navigation path without employing human senses or human actions, vetting 224 a candidate action without employing human senses or human actions, inferring 732 a workflow rule without employing human senses or human actions, finding 716 a record in a list without employing human senses or human actions, invoking 620 an agent without employing human senses or human actions, and many others, which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., user interfaces 134, language models 130, other AI models 316 (e.g., statistical method software or data mining algorithm software), tools 122, procedures 210, 216, 222, 228, and various other particular sets of instructions 116 executable by processors 110. None of these are mental concepts or present merely on paper.

In addition, some of the technical effects discussed include, e.g., increased security by vetting 224 candidate actions, increased efficiency of computational resource usage by focusing on data records and candidate actions that relate directly to performance of a user task, and increased efficiency of computational resource usage by focusing on data records and candidate actions that satisfy criteria as to security, priority, confidence, and RAI. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that the operations performed by functionality 204, and other computational activities described herein are each a technical activity which cannot be performed mentally at all, because the mechanisms in question lack I/O devices that would allow a human to somehow “read” or “write” values within the computing system as described. Hence, computing technology operational improvements such as the various examples of functionality 204 described herein are improvements to computing technology. People manifestly lack the speed and the digital communication and computation capabilities which are required to perform functionality 204 operations as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as form-filling tools, process wizards, AI-enabled tools 122 for process workflow, and other offerings that facilitate HCl in the context of data records. In some scenarios, the data records whose processing is facilitated number in the hundreds, or the thousands, or the tens of thousands. The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed pertinent to a particular embodiment. However, it does not follow from the availability of a broad context that exclusive rights are being sought herein for abstract ideas; they are not. In particular, no claim is made to HCl activities generally, or model usage generally, as opposed to the particular functionality 204 methods, systems, and devices described and claimed in the eventual final claims based on the present disclosure.

Rather, the present disclosure is focused on providing appropriately specific embodiments whose technical effects fully or partially solve particular technical problems noted herein, e.g., in connection with one of the marker phrases “how to”, “problem”, or “challenge”, or otherwise apparent to one of skill in the art. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, abbreviations, names, and symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
JSON: JavaScript® Object Notation (mark of Oracle America, Inc.).
LAN: local area network
MAC: media access control
OS: operating system
PaaS or PAAS: platform-as-a-service
RAM: random access memory
ROM: read only memory
TPU: tensor processing unit
UEFI: Unified Extensible Firmware Interface
WAN: wide area network
XML: eXtended Markup Language

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human action, but does allow coverage of computational action which is performed in response to human action. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Functionality 204 operations discussed herein (whether recited expressly in the Figures or not), are understood to be inherently non-human. A human mind cannot interface directly with a computing device to perform the functionality 204 steps taught herein. This would all be well understood by persons of skill in the art in view of the present disclosure. Moreover, one of skill understands that functionality 204 cannot be implemented merely with conventional tools and steps, because actual implementation requires the use of teachings which were first provided in the present disclosure, e.g., teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on, also referred to as “computed from”. Thus, a calculation based on X depends computationally on at least X, and may also depend computationally on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, with regard to a destination or object, may involve intervening action, such as any action recited in this disclosure or inherent in a step recited in this disclosure, yet still be understood as being performed directly by or on behalf of the party of interest. Example verbs listed herein may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, any and all of the accessing, detecting, determining, modifying, and restricting, and other steps described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims herein is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A distinction in this example is that a computing system 102 contains one or more machines 101, whereas reference numeral 101 refers to a single machine, e.g., a single laptop, a single smartphone, a single workstation, a single Internet of Things device, etc. However, reference numerals for more general categories are often omitted herein for better readability, particularly when one of skill would acknowledge that the more general category encompasses a more specific category whose reference numeral is recited.

THE FOLLOWING REMARKS PERTAIN TO PARTICULAR REFERENCE NUMERALS
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202; a user account 408 unless stated otherwise (not a human person)
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor-processor instructions (binary or interpreted/compiled to binary); may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, web browsers, UCIWRI software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
202 enhanced system, i.e., system 102 enhanced with functionality 204 as taught herein
204 UCIWRI functionality (also referred to as functionality 204 and other terms associated with reference numeral 204), e.g., a mechanism which performs or is configured to perform steps 302 (submit record and workflow rules) and 502 (receive candidate action), or steps 606 (submit natural language description with workflow rule inference instruction) and 608 (receive inferred rules), or any mechanism which performs or is configured to perform a sequence of workflow rule inference activities first disclosed herein, or a sequence of candidate action generation activities first disclosed herein, or to perform a novel method 700 first disclosed herein
226 interface, e.g., network interface card, API, user interface, language model interface, or other mechanism by or through which separable items communicate in a computing system, where examples of separable include physically separable, separately compilable, separately installable, or separably replaceable without loss of functionality
500 flowchart; 500 also refers to UCIWRI methods that are illustrated by or consistent with the FIG. 5 flowchart or any variation of the FIG. 5 flowchart described herein
600 flowchart; 600 also refers to UCIWRI methods that are illustrated by or consistent with the FIG. 6 flowchart or any variation of the FIG. 6 flowchart described herein
700 flowchart; 700 also refers to UCIWRI methods that are illustrated by or consistent with the FIG. 7 flowchart or any variation of the FIG. 7 flowchart described herein; the FIG. 7 flowchart, which incorporates the flowcharts of FIGS. 5 and 6 plus the steps implicit or express in FIGS. 1 through 7, and all other steps taught herein, or methods that are illustrated by or consistent with any variation of the FIG. 7 flowchart described herein; all UCIWRI method steps are computational or otherwise artificial, not human activity
752 any step or item discussed in the present disclosure that has not been assigned some other reference numeral; 752 may thus be shown expressly as a reference numeral for various steps or items or both, and may properly be inserted as a reference numeral (in the current disclosure or any subsequent patent application which claims priority to the current disclosure) for various steps or items or both without thereby adding new matter

### Conclusion

Some embodiments provide technology to infer 732 workflow rules 212, to generate 502 candidate actions 206 based on an inferred workflow rule, or to do both. Some embodiments provide or use user-computer interaction 218 with workflow rule inference. Some infer 732 a formal workflow rule 212 from an informal natural language 402 description 404 and context which includes sample data records 304 illustrating application of the rule. Some generate 502 a candidate action 206 from existing formal workflow rules 212, which are not necessarily limited to inferred rules, and from context 310 which includes data records determined 302 to be in a user account's navigational path 306. Some vet 224 candidate actions according to a confidence 430 they apply to a record, compliance 724 with user account security permissions 426, or other criteria. Embodiments facilitate 220 user-computer interaction in some scenarios by suggesting 610 the candidate action in a user interface 134 and implementing 614 a suggestion response 436, in some scenarios by offering 616 an agent 438 to perform 618 the candidate action, and in some scenarios by invoking 620 an agent to transparently perform 618 the candidate action.

Embodiments are understood to also themselves include or benefit from tested and appropriate security controls and privacy controls such as the General Data Protection Regulation (GDPR), and to comply with all applicable laws and regulations, e.g., the European Union Artificial Intelligence Act (EU AI Act) when applicable. Use of the tools and techniques taught herein can be done together with such controls in compliance with such laws and regulations.

Although Microsoft technology is used in some examples, the teachings herein are not limited to use in technology supplied or administered by Microsoft. Under a suitable license, for example, the present teachings could be embodied in products or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such a standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method of facilitating a continued human-machine interaction, the method performed by a computing system, the method comprising:
determining that a data record is in a navigation path of a user account;
submitting the data record and a formal workflow rule to a language model with an action generation prompt to determine whether any formal workflow rule applies to the data record and to output any candidate action corresponding to any formal workflow rule that applies to the data record;
receiving from the language model a candidate action; and
using the candidate action to facilitate the continued human-machine interaction.

2. The method of claim 1, further comprising vetting the candidate action prior to completion of using the candidate action to facilitate the continued human-machine interaction.

3. The method of claim 1, further comprising, prior to submitting the action generation prompt:
collecting a natural language description of an informal workflow rule;
obtaining a sample record which illustrates the informal workflow rule;
submitting the natural language description and the sample record to the language model with a rule inference prompt to infer at least one formal workflow rule and to output the at least one formal workflow rule in a formal notation; and
receiving from the language model the formal workflow rule in the formal notation.

4. The method of claim 3, wherein obtaining the sample record which illustrates the informal workflow rule comprises at least one of:
clustering records according to a similarity of user accounts which created and updated a record;
applying a heuristic;
mining data in at least one set of data records; or
randomly sampling at least one set of data records.

5. The method of claim 1, wherein determining that the data record is in the navigation path of the user account comprises at least one of:
detecting that the user account navigated to the data record in a user interface;
detecting that the data record is open in a user interface in a user account session;
analyzing historical data of navigation during the continued human-machine interaction;
finding the data record in a list of at least one most recently used data records of the user account;
finding the data record in a list of at least one most frequently used data records of the user account;
finding the data record in a list of at least one data record designated as associated with a user task being performed by or on behalf of the user account;
analyzing historical data of at least one user account response to at least one other candidate action;
analyzing historical data about data records targeted by a set of user accounts; or
analyzing historical data about actions taken on other data records by a set of user accounts.

6. The method of claim 1, further comprising submitting to the language model at least one of:
the natural language description of the informal workflow rule;
data used for determining that the data record is in the navigation path of the user account;
historical data of a response by the user account to a suggestion of a particular candidate action;
historical data of a response by a member of a set of user accounts to a suggestion of a particular candidate action; or
a portion of the data record.

7. The method of claim 1, wherein using the candidate action to facilitate the continued human-machine interaction comprises at least one of:
suggesting the candidate action in a user interface, getting a suggestion response via the user interface, and implementing the suggestion response;
offering access to at least one agent to perform the candidate action, getting an agent offer response via the user interface, and implementing the agent offer response; or
invoking at least one agent to perform the candidate action transparently to the user account.

8. A computing system configured to facilitate a continued human-machine interaction, the system comprising:
a digital memory;
a processor in operable communication with the digital memory;
an artificial intelligence model or an interface to an artificial intelligence model;
a candidate action suggestion procedure which comprises instructions which upon execution by a processor determine that a data record is in a navigation path of a user account, prompt the artificial intelligence model to determine whether any formal workflow rule applies to the data record, and receive from the artificial intelligence model a candidate action; and
an interaction facilitation procedure which comprises instructions which upon execution by a processor performs at least one of: suggesting the candidate action in a user interface and getting a suggestion response via the user interface, offering access to at least one agent to perform the candidate action and getting an agent offer response via the user interface, or invoking at least one agent to perform the candidate action transparently to the user account.

9. The computing system of claim 8, further comprising a workflow rule inference procedure which comprises instructions which upon execution by a processor collect a natural language description of an informal workflow rule, obtain a sample record which illustrates the informal workflow rule, prompt at least one language model to infer at least one formal workflow rule and to output the at least one formal workflow rule in a formal notation, and receive from the at least one language model at least one formal workflow rule in the formal notation.

10. The computing system of claim 8, further comprising a candidate action vetting procedure which comprises instructions which upon execution by a processor vet the candidate action according to at least one of:
a permission of the user account;
a role of the user account;
a data leak risk;
a confidence level assigned by the language model;
a priority level; or
a responsible artificial intelligence criterion.

11. The computing system of claim 8, wherein the artificial intelligence model comprises at least one of: a language model, a machine learning network, a random forest, a decision tree, or a set of clusters.

12. The computing system of claim 8, further comprising instructions which upon execution by a processor hook into a form load procedure and generate at least one candidate action in response to the user account loading a record.

13. The computing system of claim 8, further comprising instructions which upon execution by a processor determine whether to include a particular data record in the prompt to determine whether any formal workflow rule applies to the particular data record, computed from at least one of:
an expiration date;
a deadline; or
an association of the particular data record with an escalation process.

14. The computing system of claim 8, further comprising at least one of:
an instruction in the prompt to determine whether any formal workflow rule applies to the data record, the instruction comprising an instruction to provide a rationale for why an action is considered applicable; or
a data structure which links the candidate action to the formal workflow rule which was used to generate the candidate action.

15. The computing system of claim 8, wherein the formal workflow rule formal notation comprises at least one of:
a language-independent data format;
a markup language format;
an algorithmic format; or
a mathematical format.

16. A computer-readable storage medium configured with data and instructions which upon execution by a processor of a computing system perform a method of facilitating a continued human-machine interaction, the method comprising:
determining that a data record is in a navigation path of a user account;
submitting the data record and a formal workflow rule to a language model with an action generation prompt to determine whether any formal workflow rule applies to the data record and to output any candidate action corresponding to any formal workflow rule that applies to the data record;
receiving from the language model a candidate action;
vetting the candidate action; and
using the candidate action to facilitate the continued human-machine interaction.

17. The computer-readable storage medium of claim 16, wherein vetting the candidate action comprises confirming that the candidate action is consistent with a permission of the user account.

18. The computer-readable storage medium of claim 16, wherein vetting the candidate action comprises at least one of:
confirming that the candidate action poses a data leak risk below a specified risk threshold;
confirming that the candidate action has a confidence level above a specified confidence threshold;
confirming that the candidate action has a priority level above a specified priority threshold; or
confirming that the candidate action satisfies a specified responsible artificial intelligence criterion.

19. The computer-readable storage medium of claim 16, wherein using the candidate action to facilitate the continued human-machine interaction comprises at least partially proactively filling a form.

20. The computer-readable storage medium of claim 16, wherein using the candidate action to facilitate the continued human-machine interaction comprises at least one of:
proactively scheduling a meeting; or
proactively drafting an email.
